(19) United States
(12) Patent Application Publication
(10) Pub. No.: US 2025/0260106 A1
(43) Pub. Date: Aug. 14, 2025

(54) SOLID STATE ELECTROLYTE BATTERY CELL IN ELONGATED CONTAINER

(71) Applicant: Schaeffler Technologies AG & Co. KG, Herzogenaurach (DE)

(72) Inventors: Rashid FARAHATI, Copley, OH (US); Kewei LIU, Wadsworth, OH (US)

(21) Appl. No.: 18/440,955

(22) Filed: Feb. 13, 2024

(51) Int. Cl. H01M 50/211; H01M 10/0585

(52) U.S. Cl. CPC H01M 50/211; H01M 10/0585; H01M 2300/0068; H01M 2300/0082

(57) ABSTRACT

A battery includes an elongated container including at least one elongated wall extending in a longitudinal direction between a first end wall and a second end wall; and a plurality of battery units stacked inside of the container along a stacking direction that intersects the at least one elongated wall. Each battery unit includes an anode, a cathode and a solid electrolyte between the anode and the cathode. Each battery unit has a length in the longitudinal direction, a thickness in the stacking direction and a width in a lateral direction. The longitudinal direction and the lateral direction are perpendicular to the stacking direction.

### TECHNICAL FIELD

The present disclosure relates generally battery cells in container design, and more specifically to solid state electrolyte battery cells in container design.

### BACKGROUND

Currently, the state of the art in battery cell packaging are cylindrical battery cell, pouch battery cell and prismatic battery cell. Since solid state electrolyte battery cells are stiff and brittle it is difficult to fit in the cylindrical shape. Therefore, these solids state electrolyte battery cells are available in pouch cell shape.

### SUMMARY

A battery includes an elongated container including at least one elongated wall extending in a longitudinal direction between a first end wall and a second end wall; and a plurality of battery units stacked inside of the container along a stacking direction that intersects the at least one elongated wall. Each battery unit includes an anode, a cathode and a solid electrolyte between the anode and the cathode. Each battery unit has a length in the longitudinal direction, a thickness in the stacking direction and a width in a lateral direction. The longitudinal direction and the lateral direction are perpendicular to the stacking direction.

In examples, at least two of the battery units having different widths than each other.

In examples, in the stacking direction, the battery units include a first end battery unit, a second end battery unit and a plurality of interior battery units between the first end battery unit and the second end battery unit, the first end battery unit and the second end battery unit each having lesser widths than each of the interior battery units.

In examples, the interior battery units includes a middle battery unit midway between the first end battery unit and the second end battery unit, the interior battery units further including first intermediate battery units between the middle battery unit and the first end battery unit, the first intermediate battery units progressively increasing in width in the stacking direction toward the middle battery unit, the interior battery units further including second intermediate battery units between the middle battery unit and the second end battery unit, the second intermediate battery units progressively increasing in width in the stacking direction toward the middle battery unit.

In examples, the first end battery unit, the second end battery unit, the first intermediate battery units and the second intermediate battery units each have approximately a same thickness and length.

In examples, the at least one elongated wall is a single wall having a cylindrical shape as viewed in the longitudinal direction.

In examples, the at least one elongated wall is six walls having a hexagonal shape as viewed in the longitudinal direction.

In examples, the hexagonal shape forms a regular hexagon.

In examples, the hexagonal shape forms an irregular regular hexagon, the stacking direction intersecting two of the six walls, the two intersected walls each having a greater width than each of the other four walls.

In examples, the solid electrolytes are formed of a non-flammable ceramic or polymer material.

In examples, the each of the anodes, the cathodes and the solid electrolyte is shaped as a sheet, each battery unit is formed of the anode, cathode and the solid electrolyte laminated together.

A battery assembly is also provided including a plurality of the batteries arranged into a pattern of repeating rows and columns as viewed longitudinally, and the pattern is a hexagonal packing of circles or hexagons.

A method of constructing a battery is also provided, including forming a plurality of battery units, each battery unit being formed by laminating an anode, a cathode and a solid electrolyte together, each battery unit having a thickness, a length and a width; and stacking the battery units in a stacking direction in an elongated container including at least one elongated wall extending in a longitudinal direction between a first end wall and a second end wall, the stacking direction being perpendicular to the longitudinal direction.

In examples, at least two of the battery units having different widths than each other.

In examples, each of the anodes, the cathodes and the solid electrolyte has a first lateral edge, a second lateral edge, a first longitudinal edge, a second longitudinal edge and two planar surfaces each extending from the first lateral edge to the second lateral edge and from the first longitudinal edge to the second longitudinal edge, the stacking including positioning the battery units within the container such that the first lateral edge, the second lateral edge and/or one of the two planar surfaces of the cathode and/or anode of each battery unit contacts the at least one elongated wall.

In examples, the at least one elongated wall is a single wall having a cylindrical shape as viewed in the longitudinal direction, the stacking including positioning the battery units within the container such that the first lateral edge, the second lateral edge and/or one of the two planar surfaces of the cathode and/or anode of each battery unit contacts the single wall.

In examples, the battery units include a first end battery unit, a second end battery unit and a plurality of interior battery units between the first end battery unit and the second end battery unit, the first end battery unit and the second end battery unit each having a lesser width than each of the interior battery units, the interior battery units includes a middle battery unit midway between the first end battery unit and the second end battery unit, the interior battery units further including first intermediate battery units between the middle battery unit and the first end battery unit, the first intermediate battery units progressively increasing in width in the stacking direction toward the middle battery unit, the interior battery units further including second intermediate battery units between the middle battery unit and the second end battery unit, the second intermediate battery units progressively increasing in width in the stacking direction toward the middle battery unit, the first end battery unit, the second end battery unit, the middle battery unit, the first intermediate battery units, and the second intermediate battery units each being positioned within the container such that the first lateral edge, the second lateral edge and/or one of the two planar surfaces of the cathode and/or anode of each of the first end battery unit, the second end battery unit, the middle battery unit, the first intermediate battery units, and the second intermediate battery units contacts the single wall.

In examples, the at least one elongated wall is six walls having a hexagonal shape as viewed in the longitudinal direction, the stacking including positioning the battery units within the container such that the first lateral edge, the second lateral edge and/or one of the two planar surfaces of the cathode and/or anode of each battery unit contacts at least one of the six walls.

In examples, the battery units include a first end battery unit, a second end battery unit and a plurality of interior battery units between the first end battery unit and the second end battery unit, the first end battery unit and the second end battery unit each having a lesser width than each of the interior battery units, the first end battery unit being positioned within the container such that one of the planar surfaces of the anode or cathode of the first end battery unit contacting a first wall of the container, the first end battery unit being positioned within the container such that one of the planar surfaces of the anode or cathode of the second end battery unit contacting a second wall of the container that is opposite of the first wall, the stacking direction intersecting the first wall and the second wall, the interior battery units each being positioned within the container such that the first lateral edge, the second lateral edge and/or one of the two planar surfaces of the cathode and/or anode of each interior battery unit contacts a third wall and/or a fourth wall of the container or contacts a fifth wall and/or a sixth wall of the container, the third wall and the fourth wall being directly connected to the first wall, the fifth wall and the sixth wall being directly connected to the second wall.

In examples, the interior battery units includes a middle battery unit midway between the first end battery unit and the second end battery unit, the interior battery units further including first intermediate battery units between the middle battery unit and the first end battery unit, the first intermediate battery units progressively increasing in width in the stacking direction toward the middle battery unit, the interior battery units further including second intermediate battery units between the middle battery unit and the second end battery unit, the second intermediate battery units progressively increasing in width in the stacking direction toward the middle battery unit, the first intermediate battery units each being positioned within the container such that the first lateral edge, the second lateral edge and/or one of the two planar surfaces of the cathode and/or anode of each first intermediate battery unit contacts the third wall and/or the fourth wall of the container, the second intermediate battery units each being positioned within the container such that the first lateral edge, the second lateral edge and/or one of the two planar surfaces of the cathode and/or anode of each second intermediate battery unit contacts the fifth wall and/or the sixth wall of the container.

### BRIEF DESCRIPTION OF THE DRAWINGS

The present disclosure is described below by reference to the following drawings, in which:

FIG. 1a shows a cross-sectional view of a battery assembly including a plurality of batteries having a circalunar cross-section arranged into a pattern of repeating rows and columns as viewed longitudinally;

FIG. 1b shows a perspective view of an exemplary battery of FIG. 1a, viewing the container longitudinally with a top wall omitted to illustrate the battery units;

FIG. 1c shows a schematic side view of the battery shown in FIG. 1b;

FIG. 1d schematically shows the general shape of each of the anodes, the cathodes and the solid electrolyte of the battery shown in FIG. 1b;

FIG. 1e shows the tabs of the anodes and cathodes;

FIG. 2a shows a cross-sectional view of a battery assembly including a plurality of batteries having a regular hexagonal cross-section arranged into a pattern of repeating rows and columns as viewed longitudinally;

FIG. 2b shows a cross-sectional longitudinally facing view of an exemplary battery of FIG. 2a;

FIG. 3a shows a cross-sectional view of a battery assembly including a plurality of batteries having an irregular hexagonal cross-section arranged into a pattern of repeating rows and columns as viewed longitudinally;

FIG. 3b shows a cross-sectional longitudinally facing view of an exemplary battery of FIG. 3a; and

FIG. 4 shows a longitudinally facing cross-sectional view of another exemplary battery.

### DETAILED DESCRIPTION

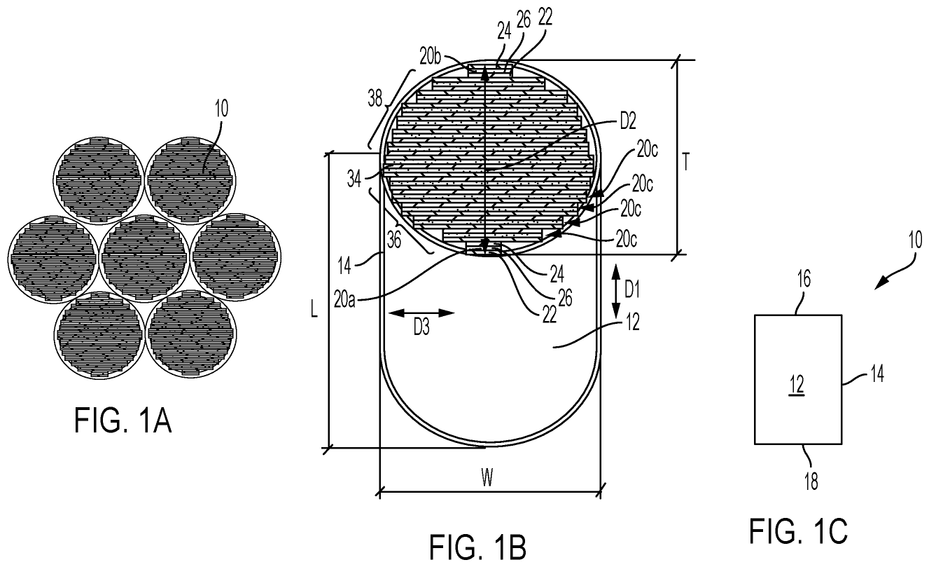

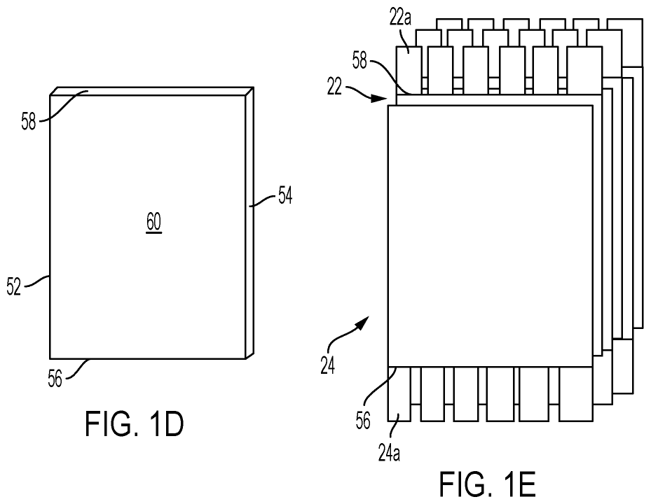

FIG. 1a shows a cross-sectional view of a battery assembly including a plurality of batteries 10 arranged into a pattern of repeating rows and columns as viewed longitudinally. Batteries 10 have a circular cross-section when view longitudinally, and thus the pattern is a hexagonal packing of circles when view longitudinally.

FIGS. 1b to 1e shows various views of an exemplary battery 10 and/or components thereof in accordance with the present disclosure. Battery 10 includes an elongated container 12. As shown by viewing FIGS. 1b and 1c together, the elongated container 12 includes at least one elongated wall 14 extending in a longitudinal direction between a first end wall 16 and a second end wall 18. A plurality of battery units 20a to 20c are stacked inside of the container 12 along a stacking direction that intersects the at least one elongated wall 14. As shown in FIG. 1c, each battery unit 20 includes an anode 22, a cathode 24 and a solid electrolyte 26. Each battery unit 20 has a length L in a longitudinal direction D1, a thickness T in a stacking directing D2 and a width W in a lateral direction D3. The lateral direction D3 is perpendicular to the stacking direction D2. At least two of the battery units 20 have different widths than each other.

The anodes 22 each include anode material on an anode current collector and the cathodes 24 each include cathode material on a cathode current collector. The solid electrolytes 26 are formed of a non-flammable ceramic or polymer material.

In the stacking direction D2, the battery units 20 include a first end battery unit 20a, a second end battery unit 20b and a plurality of interior battery units 20c between the first end battery unit 20a and the second end battery unit 20b. The first end battery unit 20a and the second end battery unit 20b each have lesser widths than each of the interior battery units 20c.

The interior battery units 20c include a middle battery unit 34 midway between the first end battery unit 20a and the second end battery unit 20b. The interior battery units 20c further include first intermediate battery units 36 between the middle battery unit 34 and the first end battery unit 20a. The first intermediate battery units 36 are progressively increasing in width in the stacking direction toward the middle battery unit 34. The first intermediate battery units 36, considered together, have an average width that is less than the width of the middle battery unit 34 and greater than the width of the first end battery unit 20a.

The interior battery units 20c further include second intermediate battery units 38 between the middle battery unit 34 and the second end battery unit 20b. The second intermediate battery units 38 are progressively increasing in width in the stacking direction toward the middle battery unit 34. The second intermediate battery units 38, considered together, have an average width that is less than the width of the middle battery unit 34 and greater than the width of the second end battery unit 20b.

The first end battery unit 20a and first intermediate battery units 36 together form a first battery section (bottom half of the battery as view longitudinally in FIG. 1b), and the second end battery unit 20b and second intermediate battery units 38 together form a second battery section (top half of the battery as view longitudinally in FIG. 1b). The first battery section and the second battery section are symmetrical in terms of the width of the end battery units 20a, 20b and the intermediate battery units 36, 38 with respect to each other when considered with respect to the middle battery unit 34.

The first end battery unit 20a, the second end battery unit 20b and the intermediate battery units 36, 38 each have each have approximately (+/−5%) a same thickness and length.

In the examples shown in FIGS. 1a to 1c, at least one elongated wall 14 is a single wall 44 having a cylindrical shape 40.

FIG. 1d schematically shows that each of the anodes 22, the cathodes 24 and the solid electrolyte 26 are shaped as a sheet. Each of anodes 22, cathodes 24 and solid electrolyte 26 has a first lateral edge 52 and a second lateral edge 54 that delimit the width W, a first longitudinal edge 56 and a second longitudinal edge 58 that delimit the length L, and two planar surfaces—a planar surface 60 and a planar surface facing away from surface 60—that delimit the thickness T. Each of the planar surfaces extends from the first lateral edge 52 to the second lateral edge 54 and from the first longitudinal edge 56 to the second longitudinal edge 58.

Referring to FIGS. 1b and 1d together, the first end battery unit 20a, the second end battery unit 20b, the middle battery unit 34, the first intermediate battery units 36, and the second intermediate battery units 38 are each being positioned within the container 12 such that the first lateral edge 52, the second lateral edge 54 and/or one of the two planar surfaces 60 of the cathode 24 and/or anode 22 of each of the first end battery unit 20a, the second end battery unit 20b, the middle battery unit 34, the first intermediate battery units 36, and the second intermediate battery units 38 contacts the single wall 14. In the example shown in FIG. 1b, as cathodes 24 face away from the center of the battery 10, cathodes 24 contact wall 14 at both lateral edges 52, 54 and/or cathodes 24 contact wall 14 at planar surface 60 adjacent to both edges 52, 54.

FIG. 1e schematically shows that each of the anodes 22 includes one or more tabs 22a formed by the anode current collector and protruding past the second longitudinal edge 58 past the anode material. Similarly, each of the cathode 24 includes one or more tabs 24a formed by the anode current collector and protruding past the first longitudinal edge 56 past the cathode material. In the example shown in FIGS. 1a to 1e, the battery cell is a monopolar cell, and thus each of the anodes and cathodes includes one or more tabs. In other examples, a bipolar battery cell can be used, and only the anode of one end battery unit and the cathode of another end battery unit can include the one or more tabs.

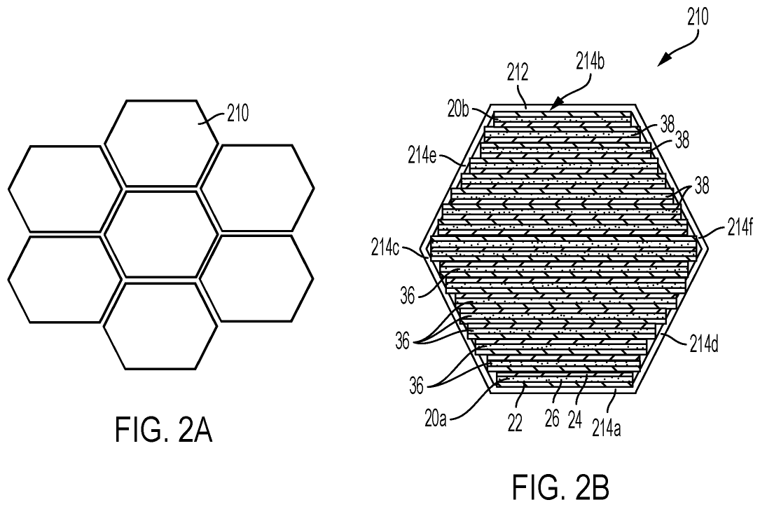

FIG. 2a shows a cross-sectional view of a battery assembly including a plurality of batteries 210 arranged into a pattern of repeating rows and columns as viewed longitudinally. Batteries 210 have a regular hexagonal cross-section when view longitudinally, and thus the pattern is a hexagonal packing of regular hexagons when view longitudinally.

FIG. 2b shows a longitudinally facing cross-sectional view of an exemplary battery 210. Battery 210 is constructed in the same manner as battery 10, except with a hexagonal cross-section. Instead of elongated container 212 having a single elongated wall 14, elongated container 212 includes six walls 214a to 214f. In substantially the same manner as with battery 10, battery 210 includes a plurality of battery units 20a to 20c stacked inside of the container 212, with each battery unit 20 including an anode 22, a cathode 24 and a solid electrolyte 26. As with in battery 10, each battery unit 20 has a length L in a longitudinal direction D1, a thickness T in a stacking directing D2 and a width W in a lateral direction D3, and the first end battery unit 20a and the second end battery unit 20b each have lesser widths than each of the interior battery units 20c. The only difference between battery 10 and battery 210 is the shape of the container 12, 212 and the widths of the units 20a to 20c, which are accommodated to the shape of the container 212.

Battery 210 includes a first wall 214a, a second wall 214b, a third wall 214c, a fourth wall 214d and fifth wall 214e and a sixth wall 214f. The walls 214a to 214f together have a regular hexagonal cross-sectional when viewed longitudinally. The stacking direction intersects the first wall 214a and the second wall 214b. The third wall 214c and the fourth wall 214d are directly connected to opposite edges of the first wall 214a and the fifth wall 214e and the sixth wall 214f are directly connected to opposite edges of the second wall 214b. Further, the third wall 214c and the fifth wall 214e are directly connected to each other and the fourth wall 214d and the sixth wall 214f are directly connected to each other.

As with battery 10, the first end battery unit 20a and first intermediate battery units 36 of battery 210 together form a first battery section (bottom half of the battery as view longitudinally in FIG. 2b), and the second end battery unit 20b and second intermediate battery units 38 of battery 210 together form a second battery section (top half of the battery as view longitudinally in FIG. 1b). The first battery section and the second battery section are symmetrical with respect to each other in terms of the width of the end battery units 20a, 20b and the intermediate battery units 36, 38 with respect to each other when considered with respect to the middle battery unit 34.

The first end battery unit 20a is positioned within the container 212 such that the planar surface 60 of the cathode 24 of the first end battery unit 20a contacts the first wall 214a of the container 214, and the second end battery unit 20b is positioned within the container 212 such that the planar surface 60 of the cathode 24 of the second end battery unit 20b contacts the second wall 214b of the container 214.

The battery units 20a to 20c are positioned within the container 12 such that the first lateral edge 52, the second lateral edge 54 and/or one of the two planar surfaces 60 of the cathode 24 and/or anode 22 of each battery unit 20 contacts at least one of the six walls 214a to 214f. In the example shown in FIG. 2b, as cathodes 24 face away from the center of the battery 10, cathodes 24 in the first battery section (bottom half of the battery as view longitudinally in FIG. 2b) contact walls 214c and 214d and cathodes 24 in the second battery section (top half of the battery as viewed longitudinally in FIG. 2b) contact walls 214e and 214f.

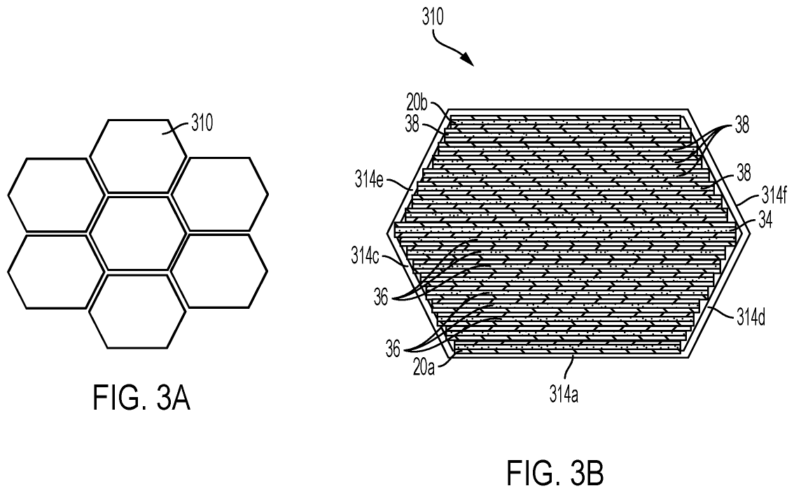

FIG. 3a shows a cross-sectional view of a battery assembly including a plurality of batteries 310 arranged into a pattern of repeating rows and columns as viewed longitudinally. Batteries 310 have an irregular hexagonal cross-section when view longitudinally, and thus the pattern is a hexagonal packing of regular hexagons when view longitudinally.

FIG. 3b shows a longitudinally facing cross-sectional view of an exemplary battery 310, which is formed in the exact same manner as battery 210, except the hexagonal cross-section of the container 312 is an irregular hexagon, instead of the regular hexagon in battery 210, and the width of the units 20a to 20c are accordingly adapted to the irregular hexagon shape. Thus, while walls 214a to 214f of container 212 are all of the same width, walls 314a and 314b of container 312 are wider than walls 314c to 314f.

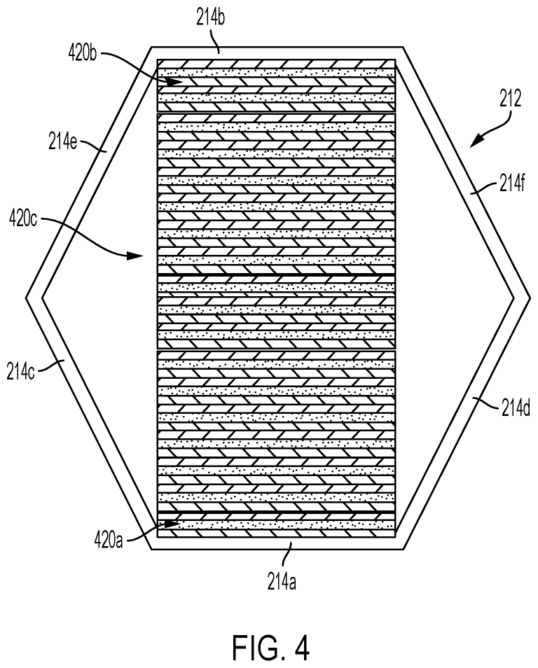

FIG. 4 shows a longitudinally facing cross-sectional view of another exemplary battery 410. Battery 410 is constructed in the same manner as battery 210, except the battery units 420a to 420c, which have the same layers as battery units 20a to 20c, each have the same width and only end battery unit 420a, 420b contact the elongated walls 214a, 214c, 214d and elongated walls 214b, 214e, 214f, respectively, of container 212. In other words, none of the interior battery units 420c contact any of elongated walls 214a to 214f.

### LIST OF REFERENCE NUMERALS

10 battery
12 container
14 at least one elongated wall
16 first end wall
18 second end wall
20a first end battery unit
20b second end battery unit
20c interior battery units
22 anode
22a one or more tabs
24 cathodes
24a one or more tabs
26 solid electrolyte
34 middle battery unit
35 central double anode
36 first intermediate battery units
38 second intermediate battery units
40 cylindrical shape
44 single wall
52 first lateral edge
54 second lateral edge
56 first longitudinal edge
58 second longitudinal edge
60 planar surface
210 battery
212 container
214 container
214a first wall
214b second wall
214c third wall
214d fourth wall
214e fifth wall
214f sixth wall
310 plurality of batteries
312 container
314a first wall
314b second wall
314c third wall
314d fourth wall
314e fifth wall
314f sixth wall
410 battery
420a first end battery unit
420b second end battery unit
420c interior battery units

What is claimed is:

1. A battery comprising:
an elongated container including at least one elongated wall extending in a longitudinal direction between a first end wall and a second end wall;
a plurality of battery units stacked inside of the container along a stacking direction that intersects the at least one elongated wall,
each battery unit including an anode, a cathode and a solid electrolyte between the anode and the cathode,
each battery unit having a length in the longitudinal direction, having a thickness in the stacking direction and a width in a lateral direction, the longitudinal direction and the lateral direction being perpendicular to the stacking direction.

2. The battery as recited in claim 1, wherein at least two of the battery units having different widths than each other.

3. The battery as recited in claim 2, wherein, in the stacking direction, the battery units include a first end battery unit, a second end battery unit and a plurality of interior battery units between the first end battery unit and the second end battery unit,
the first end battery unit and the second end battery unit each having lesser widths than each of the interior battery units.

4. The battery as recited in claim 3, wherein the interior battery units includes a middle battery unit midway between the first end battery unit and the second end battery unit,
the interior battery units further including first intermediate battery units between the middle battery unit and the first end battery unit, the first intermediate battery units progressively increasing in width in the stacking direction toward the middle battery unit,
the interior battery units further including second intermediate battery units between the middle battery unit and the second end battery unit, the second intermediate battery units progressively increasing in width in the stacking direction toward the middle battery unit.

5. The battery as recited in claim 4, wherein the first end battery unit, the second end battery unit, the first intermediate battery units and the second intermediate battery units each have approximately a same thickness and length.

6. The battery as recited in claim 1, wherein the at least one elongated wall is a single wall having a cylindrical shape as viewed in the longitudinal direction.

7. The battery as recited in claim 1, wherein the at least one elongated wall is six walls having a hexagonal shape as viewed in the longitudinal direction.

8. The battery as recited in claim 7, wherein the hexagonal shape forms a regular hexagon.

9. The battery as recited in claim 7, wherein the hexagonal shape forms an irregular regular hexagon, the stacking direction intersecting two of the six walls, the two intersected walls each having a greater width than each of the other four walls.

10. The battery as recited in claim 1, wherein the solid electrolytes are formed of a non-flammable ceramic or polymer material.

11. The battery as recited in claim 1, wherein the each of the anodes, the cathodes and the solid electrolyte is shaped as a sheet, each battery unit is formed of the anode, cathode and the solid electrolyte laminated together.

12. A battery assembly comprising:
a plurality of the batteries as recited in claim 1 arranged into a pattern of repeating rows and columns as viewed longitudinally, the pattern being a hexagonal packing of circles or hexagons.

13. A method of constructing a battery comprising:
forming a plurality of battery units, each battery unit being formed by laminating an anode, a cathode and a solid electrolyte together, each battery unit having a thickness, a length and a width; and
stacking the battery units in a stacking direction in an elongated container including at least one elongated wall extending in a longitudinal direction between a first end wall and a second end wall, the stacking direction being perpendicular to the longitudinal direction.

14. The method as recited in claim 13 wherein at least two of the battery units having different widths than each other.

15. The method as recited in claim 14 wherein each of the anodes, the cathodes and the solid electrolyte has a first lateral edge, a second lateral edge, a first longitudinal edge, a second longitudinal edge and two planar surfaces each extending from the first lateral edge to the second lateral edge and from the first longitudinal edge to the second longitudinal edge,
the stacking including positioning the battery units within the container such that the first lateral edge, the second lateral edge and/or one of the two planar surfaces of the cathode and/or anode of each battery unit contacts the at least one elongated wall.

16. The method as recited in claim 15, wherein the at least one elongated wall is a single wall having a cylindrical shape as viewed in the longitudinal direction,
the stacking including positioning the battery units within the container such that the first lateral edge, the second lateral edge and/or one of the two planar surfaces of the cathode and/or anode of each battery unit contacts the single wall.

17. The method as recited in claim 16, wherein the battery units include a first end battery unit, a second end battery unit and a plurality of interior battery units between the first end battery unit and the second end battery unit,
the first end battery unit and the second end battery unit each having a lesser width than each of the interior battery units,
the interior battery units includes a middle battery unit midway between the first end battery unit and the second end battery unit,
the interior battery units further including first intermediate battery units between the middle battery unit and the first end battery unit, the first intermediate battery units progressively increasing in width in the stacking direction toward the middle battery unit,
the interior battery units further including second intermediate battery units between the middle battery unit and the second end battery unit, the second intermediate battery units progressively increasing in width in the stacking direction toward the middle battery unit,
the first end battery unit, the second end battery unit, the middle battery unit, the first intermediate battery units, and the second intermediate battery units each being positioned within the container such that the first lateral edge, the second lateral edge and/or one of the two planar surfaces of the cathode and/or anode of each of the first end battery unit, the second end battery unit, the middle battery unit, the first intermediate battery units, and the second intermediate battery units contacts the single wall.

18. The method as recited in claim 15, wherein the at least one elongated wall is six walls having a hexagonal shape as viewed in the longitudinal direction,
the stacking including positioning the battery units within the container such that the first lateral edge, the second lateral edge and/or one of the two planar surfaces of the cathode and/or anode of each battery unit contacts at least one of the six walls.

19. The method as recited in claim 18, wherein the battery units include a first end battery unit, a second end battery unit and a plurality of interior battery units between the first end battery unit and the second end battery unit,
the first end battery unit and the second end battery unit each having a lesser width than each of the interior battery units,
the first end battery unit being positioned within the container such that one of the planar surfaces of the anode or cathode of the first end battery unit contacting a first wall of the container,
the first end battery unit being positioned within the container such that one of the planar surfaces of the anode or cathode of the second end battery unit contacting a second wall of the container that is opposite of the first wall, the stacking direction intersecting the first wall and the second wall,
the interior battery units each being positioned within the container such that the first lateral edge, the second lateral edge and/or one of the two planar surfaces of the cathode and/or anode of each interior battery unit contacts a third wall and/or a fourth wall of the container or contacts a fifth wall and/or a sixth wall of the container,
the third wall and the fourth wall being directly connected to the first wall,
the fifth wall and the sixth wall being directly connected to the second wall.

20. The method as recited in claim 19, wherein the interior battery units includes a middle battery unit midway between the first end battery unit and the second end battery unit,
the interior battery units further including first intermediate battery units between the middle battery unit and the first end battery unit, the first intermediate battery units progressively increasing in width in the stacking direction toward the middle battery unit,
the interior battery units further including second intermediate battery units between the middle battery unit and the second end battery unit, the second intermediate battery units progressively increasing in width in the stacking direction toward the middle battery unit,
the first intermediate battery units each being positioned within the container such that the first lateral edge, the second lateral edge and/or one of the two planar surfaces of the cathode and/or anode of each first intermediate battery unit contacts the third wall and/or the fourth wall of the container,
the second intermediate battery units each being positioned within the container such that the first lateral edge, the second lateral edge and/or one of the two planar surfaces of the cathode and/or anode of each second intermediate battery unit contacts the fifth wall and/or the sixth wall of the container.
